(19) United States
(12) Patent Application Publication
(10) Pub. No.: US 2011/0058389 A1
(43) Pub. Date: Mar. 10, 2011

(54) BRIGHTNESS ENHANCEMENT FILM AND BACKLIGHT MODULE

(75) Inventors: Tzeng-Ke Shiau, Jiangsu (CN); Ching-Shiang Li, Jiangsu (CN); Kuo-Tung Tiao, Jiangsu (CN)

(73) Assignee: CORETRONIC CORPORATION, Hsin-Chu (TW)

(21) Appl. No.: 12/768,748

(22) Filed: Apr. 28, 2010

(30) Foreign Application Priority Data
Sep. 10, 2009 (TW) 98130611

(51) Int. Cl. F21V 7/04; F21V 7/00; F21V 5/02

(52) U.S. Cl. 362/607; 362/341; 362/339; 362/609

(57) ABSTRACT

A brightness enhancement film (BEF) includes a light transmissive substrate, a plurality of optical structures, a reflective layer, and a prism layer. The light transmissive substrate has a first surface and a second surface opposite to the first surface. The optical structures are disposed on the first surface. The reflective layer is disposed on the second surface and has a plurality of light transmissive openings. The prism layer covers the reflective layer and the second surface and includes a plurality of prism structures protruded away from the second surface. A backlight module is also provided.

### CROSS-REFERENCE TO RELATED APPLICATION

This application claims the priority benefit of Taiwan application serial no. 98130611, filed on Sep. 10, 2009. The entirety of the above-mentioned patent application is hereby incorporated by reference herein and made a part of specification.

### BACKGROUND OF THE INVENTION

1. Field of the Invention

The invention generally relates to an optical film and a light source module using the optical film, and more particularly, to a brightness enhancement film (BEF) and a backlight module using the BEF.

2. Description of Related Art

Along with the development of display technology, flat panel display has replaced the conventional bulky cathode ray tube (CRT) display as the mainstream of display devices. Liquid crystal display (LCD) is one of the most commonly used display among all flat panel displays. An LCD includes a liquid crystal panel and a backlight module. The liquid crystal panel may not emit light but determine the light transmittance. Thus, a backlight module may be disposed behind the liquid crystal panel as a surface light source of the liquid crystal panel. The optical quality of a surface light source is critical to the display quality of the LCD. For example, a uniform surface light source may be disposed in order to display images correctly and reduce distortion. In addition, the range of the light emitting angle of a surface light source may be restricted to reduce light loss and increase the brightness of displayed images.

In a conventional side-type backlight module, a lower diffuser, two prism sheets with orthogonal prisms, and an upper diffuser are sequentially disposed from bottom to top on a light guide plate. The prism sheets are used for reducing the range of the light emitting angle, and the upper diffuser and the lower diffuser are used for uniforming the light and preventing moiré produced by the contour of the prisms and the liquid crystal panel. However, because four optical films are disposed on the light guide plate, the fabricating cost of the backlight module is increased, the assembly of the backlight module is complicated, and the thickness of the backlight module may not be reduced. In addition, the adoption of four optical films may cause light loss and accordingly have difficult to improve the forward luminance of the backlight module.

In addition, the Taiwan patent publication No. 200911513 discloses an optical film structure disposed on a light guide plate, wherein the optical film structure has a light transmissive body and a reflective layer disposed on an incident surface of the light transmissive body, and a lens array is disposed on a light emitting surface of the light transmissive body. Besides, the reflective layer has openings corresponding to the lenses. Moreover, the U.S. patent publication No. 20070002452 also discloses such an optical film structure. However, because the LCDs on different electronic devices (for example, a cell phone, a notebook computer, a monitor, or a TV) have different requirements to brightness distribution in different directions, and the light emitting angle range of a backlight module adopting one of foregoing two optical film structures may not change with the change of directions, such a design concept is not adaptable to different types of electronic devices. Furthermore, the U.S. Pat. No. 7,374,328 and the Taiwan patent publication No. 200846774 disclose a diffusion layer disposed at the bottom of a reflective layer, so that the light is diffused.

### SUMMARY OF THE INVENTION

Accordingly, the invention is directed to a brightness enhancement film (BEF), and the BEF may effectively increase the forward luminance of emitted light.

The invention is further directed to a backlight module, and the backlight module provides a surface light source with increased forward luminance

Additional aspects and advantages of the invention may be set forth in part in following descriptions.

In order to achieve at least one of the objectives, an embodiment of the invention provides a BEF including a light transmissive substrate, a plurality of optical structures, a reflective layer, and a prism layer. The light transmissive substrate has a first surface and a second surface opposite to the first surface. The optical structures are disposed on the first surface. The reflective layer is disposed on the second surface and has a plurality of light transmissive openings. The prism layer covers the reflective layer and the second surface and includes a plurality of prism structures protruded away from the second surface.

According to another embodiment of the invention, a backlight module including at least one light emitting device, the BEF described above, and an optical unit is provided. The light emitting device is capable of emitting a light beam. The BEF is disposed in the transmission path of the light beam. The optical unit is disposed in the transmission path of the light beam between the light emitting device and the BEF.

As described above, the embodiment or the embodiments of the invention may have at least one of the following advantages, in a BEF according to the embodiments of the invention, the prism structures of a prism layer refract an incident light so that the incident light may travel in a direction close to the normal direction of a first surface after the incident light passes through the prism structures, and when the incident light is reflected by the reflective layer and accordingly leaves the prism structures, the incident light may be refracted again by the surfaces of the prism structures and accordingly travels in a direction close to the normal direction of the first surface. Thereby, the forward luminance of the light emitted by the optical structures is increased, and a surface light source with higher brightness is provided by the backlight module according to the embodiments of the invention.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A and FIG. 1B are cross-sectional views of a backlight module in two orthogonal directions according to an embodiment of the invention.

FIG. 2A is a three dimensional view of a brightness enhancement film (BEF) in FIG. 1A.

FIG. 2B is a top view of the BEF in FIG. 2A.

FIG. 3 is a cross-sectional view of a backlight module according to another embodiment of the invention.

FIG. 4 is a cross-sectional view of a backlight module according to another embodiment of the invention.

FIG. 5 is a cross-sectional view of a backlight module according to another embodiment of the invention.

FIG. 6A is a top view of a BEF according to another embodiment of the invention.

FIG. 6B is a top view of a BEF according to another embodiment of the invention.

FIG. 7 is a cross-sectional view of a backlight module according to another embodiment of the invention.

FIG. 8 is a three dimensional view of a BEF according to another embodiment of the invention.

FIG. 9 is a three dimensional view of a BEF according to another embodiment of the invention.

FIG. 10 is a three dimensional view of a BEF according to another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

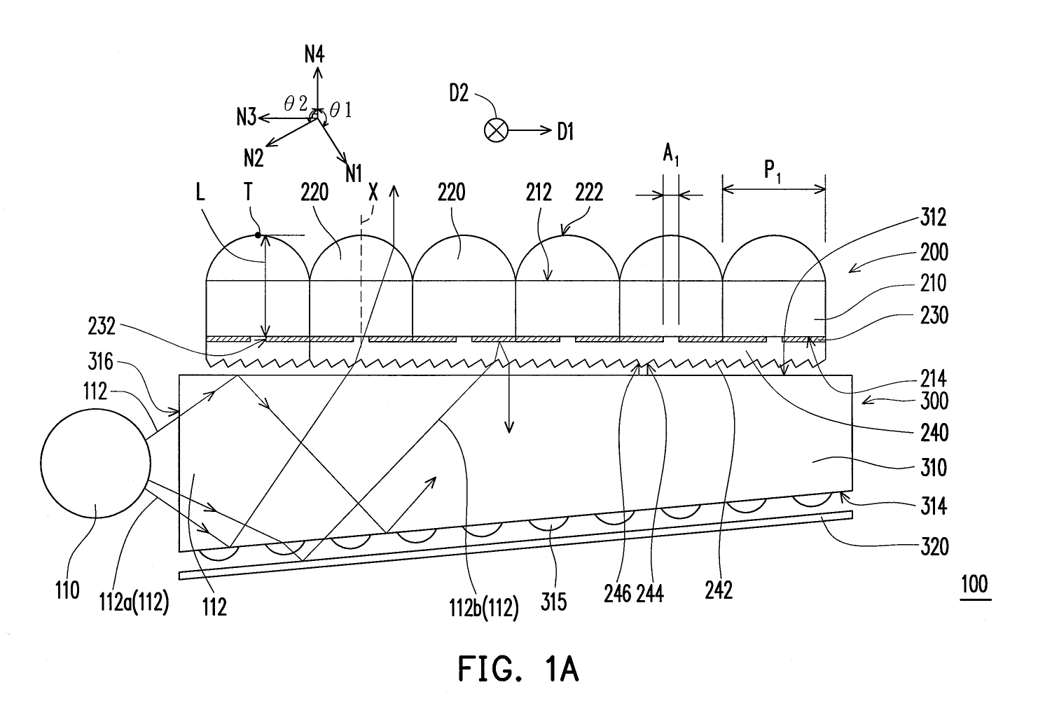

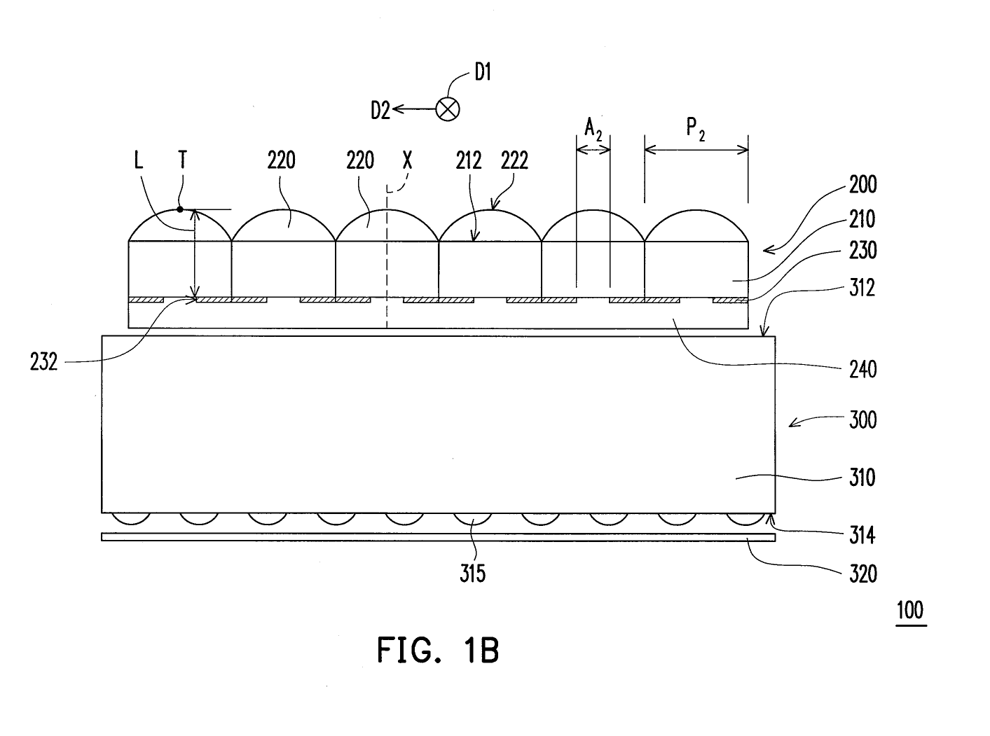

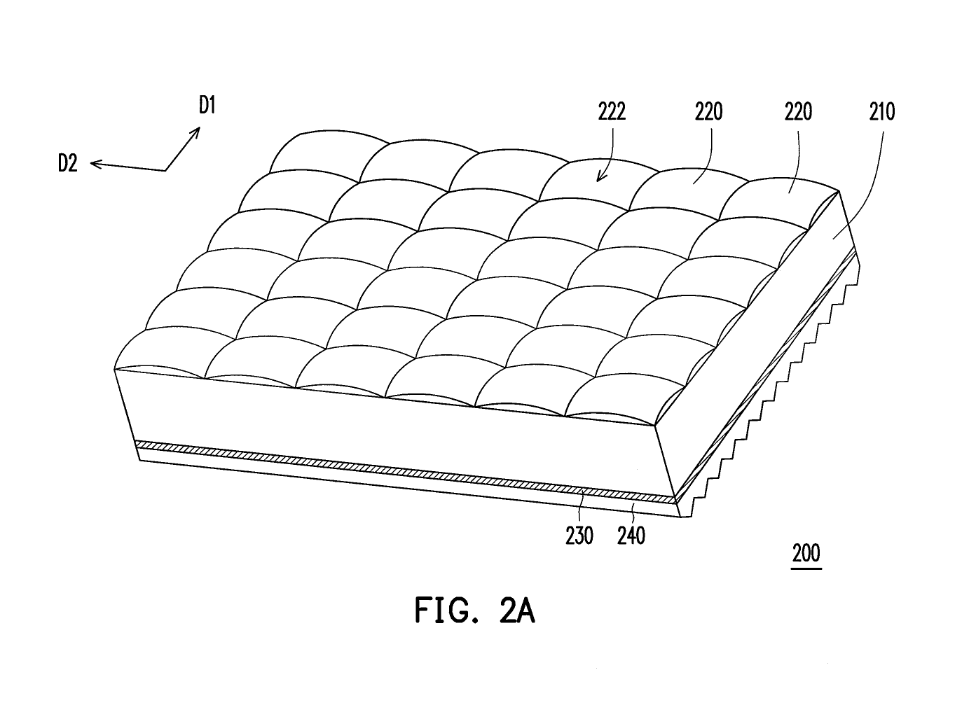

Referring to FIG. 1A, FIG. 1B, FIG. 2A, and FIG. 2B, in the embodiment, the backlight module 100 includes a light emitting device 110, a brightness enhancement film (BEF) 200, and an optical unit 300. The light emitting device 110 is capable of emitting a light beam 112. In the embodiment, the light emitting device 110 may be a cold cathode fluorescent lamp (CCFL). However, in another embodiment, the backlight module may have a plurality of light emitting devices, such as light emitting diodes (LEDs) arranged in a straight line.

The BEF 200 is disposed in the transmission path of the light beam 112. The optical unit 300 is disposed in the transmission path of the light beam 112 between the light emitting device 110 and the BEF 200. In the embodiment, the optical unit 300 includes a light guide plate 310 having a surface 312, a surface 314 opposite to the surface 312, and an incident surface 316 connecting the surface 312 and the surface 314. The light emitting device 110 is disposed beside the incident surface 316. To be specific, the light beam 112 emitted by the light emitting device 110 enters the light guide plate 310 through the incident surface 316, and the light beam 112 is totally internally reflected by the surface 312 and the surface 314 and therefore is restricted within the light guide plate 310. However, the microstructures 315 on the surface 314 of the light guide plate 310 destroy the total internal reflection. For example, a portion of the light beam 112 is reflected by the microstructures 315 to the surface 312 and passes through the surface 312. Another portion of the light beam 112 passes through the microstructures 315 and reaches a reflector 320 disposed at one side of the surface 314. The reflector 320 reflects the light beam 112 so that the light beam 112 sequentially passes through the surface 314 and the surface 312.

The BEF 200 includes a light transmissive substrate 210, a plurality of optical structures 220, a reflective layer 230, and a prism layer 240. The light transmissive substrate 210 has a first surface 212 and a second surface 214 opposite to the first surface 212. The optical structures 220 are disposed on the first surface 212. In the embodiment, each of the optical structures 220 is a lens and has a convex surface 222 facing away from the light transmissive substrate 210. The curvature radius of the convex surface 222 in a first direction D1 parallel to the first surface 212 is R₁, and the curvature radius of the convex surface 222 in a second direction D2 parallel to the first surface 212 is R₂, wherein R₁≠R₂. However, in another embodiment, there may be R₁=R₂. In the embodiment, the convex surface 222 may be a smooth curved surface or may be composed of a plurality of micro straight or curved line segments. Besides, in the embodiment, the first direction D1 is substantially perpendicular to the second direction D2. The reflective layer 230 is disposed on the second surface 214 and has a plurality of light transmissive openings 232, wherein the light transmissive openings 232 are respectively located on optical axes X of the optical structures 220. In the embodiment, the reflective layer 230 is located between the light transmissive substrate 210 and the surface 312. The distance between a vertex T of the convex surface 222 of the optical structure 220 and the corresponding light transmissive opening 232 is L, and the refractive index of the optical structures 220 is n. In the embodiment, the BEF 200 satisfies L<nR₁/(n−1) and L<nR₂/(n−1).

If the light beam 112 leaves the surface 312 at a large angle, a great part of the light beam 112 is reflected by the reflective layer 230 back into the light guide plate 310 to be used again. If the light beam 112 leaves the surface 312 at a small angle, a great part of the light beam 112 passes through the light transmissive openings 232. The optical power distribution of the light beam 112 passing through the light transmissive openings 232 may be close to Gaussian distribution, and the light beam 112 is focused by the optical structures 220 and therefore is emitted from the optical structures 220 in a direction approximately perpendicular to the first surface 212. Thereby, unlike the conventional technique with four optical films, the backlight module 100 provided by the embodiment offers a reduced light emitting angle range, and accordingly increased brightness to a liquid crystal display (LCD), with a single optical film (i.e., the BEF 200).

Moreover, the prism layer 240 covers the reflective layer 230 and the second surface 214, and the prism layer 240 includes a plurality of prism structures 242 protruded away from the second surface 214. In the embodiment, each of prism structures 242 is a prism rod, such as a triangular prism. The prism structures 242 are arranged along the first direction D1, and each of the prism structures 242 is extended along the second direction D2. In the embodiment, each of the prism structures 242 has a first prism face 244 and a second prism face 246, wherein the first prism face 244 and the second prism face 246 are extended along the second direction D2. In the embodiment, each of the prism structures 242 is non-mirror-symmetrical in the first direction D1. In other words, the normal vector N1 of the first prism face 244 forms an angle θ1 with the normal vector N4 of the first surface 212, and the normal vector N2 of the second prism face 246 forms an angle θ2 with the normal vector N4 of the first surface 212, wherein θ1≠θ2. In the embodiment, the angle θ1 falls within a range of 130 ˜170 degrees, and the angle θ2 falls within a range of 90˜110 degrees. However, the invention is not limited thereto. Additionally, in the embodiment, the first surface 212 is substantially parallel to the second surface 214, and the normal vector N3 of the incident surface 316, the normal vector N1, the normal vector N2, and the normal vector N4 are coplanar. However, the invention is not limited thereto.

The first prism face 244 refracts the light beam 112 so that the light beam 112 is transmitted in a direction close to the normal direction of the first surface 212. To be specific, after a portion of the light beam 112 (a partial light beam 112a) leaves the surface 312, the partial light beam 112a is refracted by the first prism face 244 so that the partial beam 112a is transmitted in a direction close to the normal direction of the first surface 212. Accordingly, the partial light beam 112a may be emitted toward the corresponding optical structure 220 right above a light transmissive opening 232 instead of another optical structure 220 beside the corresponding optical structure 220 after the partial light beam 112a passes through the light transmissive opening 232. After the partial light beam 112a reaches another optical structure 220 beside the corresponding optical structure 220, the travelling direction of the partial light beam 112a still greatly deviates from the normal direction of the first surface 212 and accordingly invalid light is produced. The first prism face 244 in the embodiment may effectively reduce such a problem. In the embodiment, because the light beam 112 passing through the light transmissive openings 232 is ensured to pass through the corresponding optical structures 220 and the optical structures 220 allow the light beam 112 to be emitted straightly, the BEF 200 in the embodiment may effectively increase the forward luminance and accordingly increase the brightness of the surface light source provided by the backlight module 100.

On the other hand, after a partial light beam 112b in the light beam 112 leaves the surface 312, the partial light beam 112b is refracted by the first prism faces 244 so that the partial light beam 112b is transmitted in a direction close to the normal direction of the first surface 212. After that, the partial light beam 112b is reflected by the reflective layer 230 back to the first prism faces 244. Then, the first prism faces 244 refract the partial light beam 112b again so that the partial light beam 112b is transmitted in a direction close to the normal direction of the first surface 212 again. After that, the partial light beam 112b returns to the light guide plate 310 to be used again. Accordingly, every time when the partial light beam 112b is reflected by the reflective layer 230 and accordingly returns to the light guide plate 310, the transmission direction of the partial light beam 112 gets closer to the normal direction of the first surface 212, so that the partial light beam 112b may quickly pass through the light transmissive openings 232. Thus, in the backlight module 100 provided by the embodiment, the number of times that the light beam 112 is reflected between the reflective layer 230 and the reflector 320 before passing through the light transmissive openings 232 may be effectively reduced, so that the loss of optical power is reduced and the forward luminance of the backlight module 100 is increased.

Additionally, in the embodiment, because R₁≠R₂, the BEF 200 may be applied to backlight modules having different requirements to the ranges of the light emitting angle in different directions. By appropriately setting the values of the R₁ and R₂, the backlight module 100 adopting the BEF 200 may be applied to the displays of different electronic devices, such as the LCD of a cell phone, a notebook computer, a monitor, or a TV.

In the embodiment, the width of the light transmissive openings 232 in the first direction D1 is not equal to the width of the light transmissive openings 232 in the second direction D2. However, in another embodiment, the width of the light transmissive openings 232 in the first direction D1 may also be equal to the width of the light transmissive openings 232 in the second direction D2. In the embodiment, the width of the light transmissive openings 232 in the first direction D1 is A₁, the width of the light transmissive openings 232 in the second direction D2 is A₂, the width of the convex surfaces 222 corresponding to the light transmissive openings 232 in the first direction D1 is P₁, the width of the convex surfaces 222 corresponding to the light transmissive openings 232 in the second direction D2 is P₂, and BEF 200 satisfies 0.1<A₁/P₁<0.9 and 0.1<A₂/P₂<0.9. Thereby, the range of the light emitting angle in the first direction D1 and the range of the light emitting angle range in the second direction D2 may have increased variations, and accordingly the BEF 200 and the backlight module 100 may be applied more broadly.

In the embodiment, the light transmissive openings 232 of the reflective layer 230 may be formed through a laser drilling technique. To be specific, the reflective layer 230 entirely covers the second surface 214 before a laser drilling process is performed. Then, parallel laser beams are irradiated onto the optical structures 220 from right above the BEF 200 illustrated in FIG. 1A (i.e., along a direction perpendicular to the first direction D1 and the second direction D2). Through the focusing effect of the optical structures 220, the light spots produced by the laser beams on the reflective layer 230 are the positions of the light transmissive openings 232. Because the light spots have uniform luminance distribution, the light transmissive openings 232 having similar sizes as the light spots may be drilled on the reflective layer 230 as long as the laser beams have sufficient power, and such luminance distribution of the light spots is achieved when the BEF 200 satisfies L<nR₁/(n−1) and L<nR₂/(n−1). Thus, the light transmissive openings 232 with expected sizes and positions may be formed through a single drilling process with the parallel laser light beams. Thereby, the design of the BEF 200 in the embodiment simplifies the fabricating process and reduces the cost of the backlight module 100. Contrarily, if the BEF 200 satisfies L>nR₁/(n−1) and L>nR₂/(n−1), the central luminance of the light spots is greater than the peripheral luminance of the light spots, and the power distribution of the light spots has no obvious boundary, so that controlling the sizes of the light transmissive openings 232 is difficult. As a result, the sizes of the obtained light transmissive openings 232 may be smaller than the sizes of the light spots and not up to expectation. Accordingly, the incident angle of the laser beams may be changed and multiple drilling processes may be performed by using the laser beams in order to obtain the light transmissive openings 232 having expected sizes and positions, so that the fabricating process may be complicated and the fabrication cost and fabrication time may be increased.

Besides, the light beam 112 passing through the BEF 200, and accordingly the surface light source provided by the backlight module 100 in the embodiment, may be uniformed if the BEF 200 is made to satisfy L<nR₁/(n−1) and L<nR₂/(n−1). In order to further improve the uniformity of the light beam 112 passing through the BEF 200, in the embodiment, the BEF 200 is further made to satisfy L<0.95 nR₁/(n−1) and L<0.95 nR₂/(n−1).

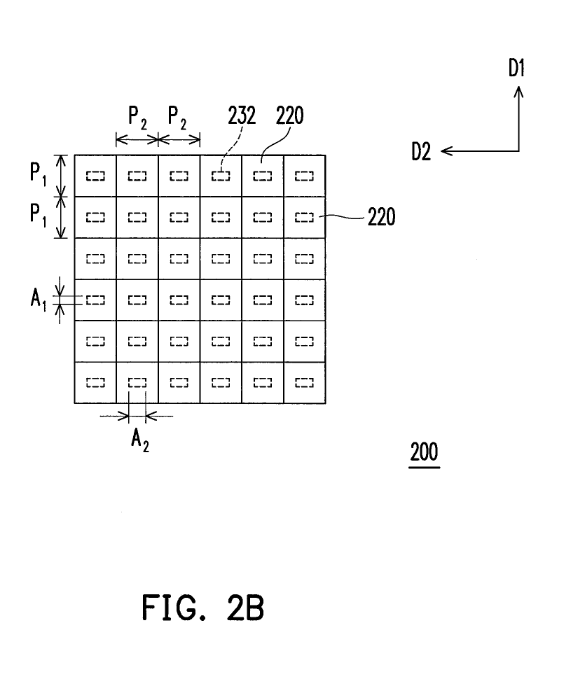

Referring to FIG. 3, the backlight module 100a in the embodiment is similar to the backlight module 100 illustrated in FIG. 1A, and the main difference between the backlight module 100 and the backlight module 100a may be described herein. In the backlight module 100 illustrated in FIG. 1A, each of the prism structures 242 has substantially the same size. However, in the BEF 200a provided by the embodiment, at least parts of the prism structures 242′ have different widths in the direction parallel to the second surface 214 (for example, the first direction D1), and at least parts of the prism structures 242′ have different heights in the direction perpendicular to the second surface 214, so that the regularity of the prism structures 242′ is broken, and moiré produced by the prism structures 242′ and the pixel array on the display panel (not shown) disposed above the backlight module 100a is reduced. In the embodiment, the positions of the prism structures 242′ may not be corresponding to the positions of the light transmissive openings 232. However, in another embodiment, the positions of the prism structures 242′ may also be corresponding to the positions of the light transmissive openings 232 appropriately.

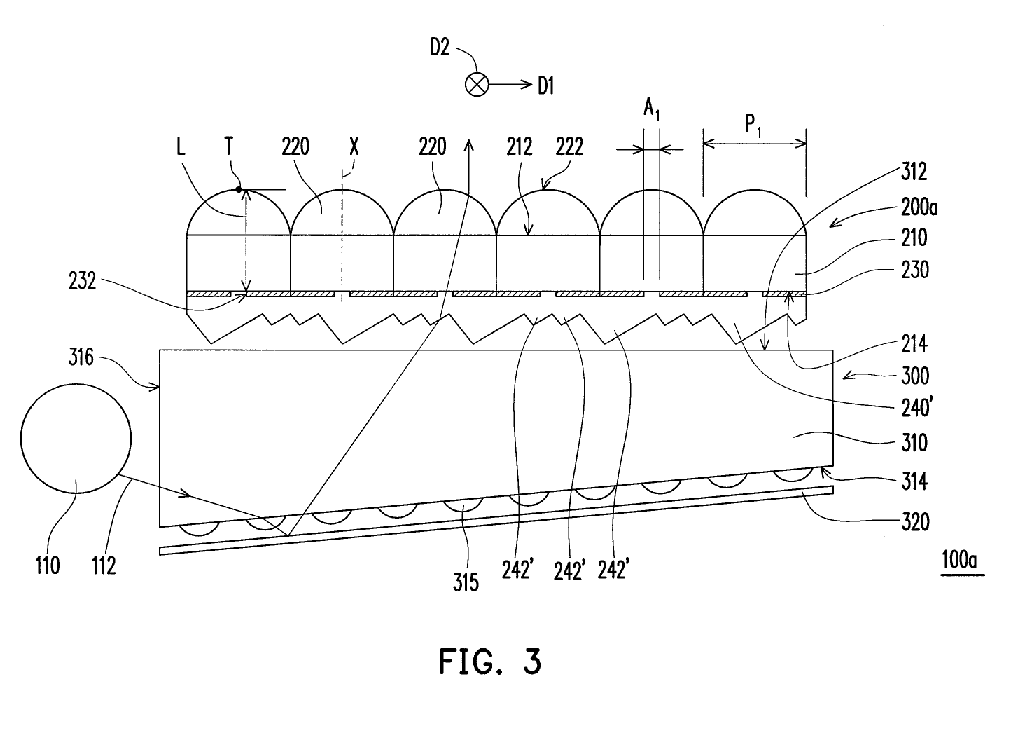

Referring to FIG. 4, the backlight module 100b in the embodiment is similar to the backlight module 100 illustrated in FIG. 1A, and the difference between the backlight module 100 and the backlight module 100b may be described herein. In the backlight module 100b provided by the embodiment, two light sources 110 are respectively disposed at two opposite sides of the light guide plate 310. Besides, in the embodiment, the prism structures 242″ of the BEF 200b are in mirror symmetry in the first direction D1. To be specific, the normal vector N1′ of the first prism faces 244″ of the prism structures 242″ forms an angle θ1′ with the normal vector N4 of the first surface 212, and the normal vector N2′ of the second prism faces 246″ of the prism structures 242″ forms an angle θ2 with the normal vector N4 of the first surface 212′, wherein θ1′=θ2′. Such a design is suitable for the backlight module 100b with two light incident directions. In the embodiment, both the angles θ1′ and θ2′ fall within a range of 130˜170 degrees. However, the invention is not limited thereto. Besides, the first prism faces 244″ are capable of refracting the light emitted by the light emitting device 110 at the left side in FIG. 4 so that the light is transmitted in a direction close to the normal direction of the first surface 212, and the second prism faces 246″ are capable of refracting the light emitted by the light emitting device 110 at the right side in FIG. 4 so that the light is transmitted in a direction close to the normal direction of the first surface 212.

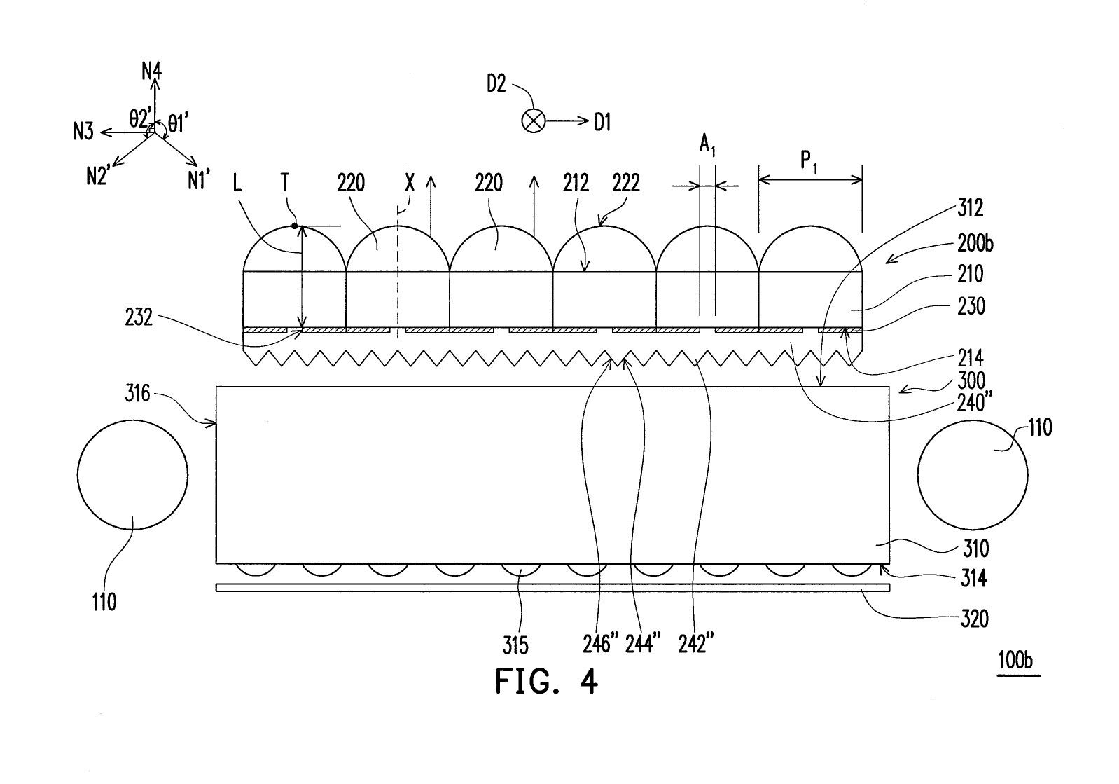

Referring to FIG. 5, the backlight module 100c in the embodiment is similar to the backlight module 100 illustrated in FIG. 1A and FIG. 1B, and the main difference between the backlight module 100 and the backlight module 100c may be described herein. In the embodiment, the prism structures 242″ of the BEF 200c in the embodiment are polygonal pyramids, such as tetragonal pyramids. The cross section of each tetragonal pyramid in another direction is the same as the cross section illustrated in FIG. 1A. In other words, each tetragonal pyramid includes cross sections connected to each other, such as the first prism face 244 and the second prism face 246 illustrated in FIG. 1A and the third prism face 248 and the fourth prism face 249 illustrated in FIG. 5. The prism structures 242″ may refract light in both the first direction D1 and the second direction D2 so that the light may be transmitted in a direction close to the normal direction of the first surface 212.

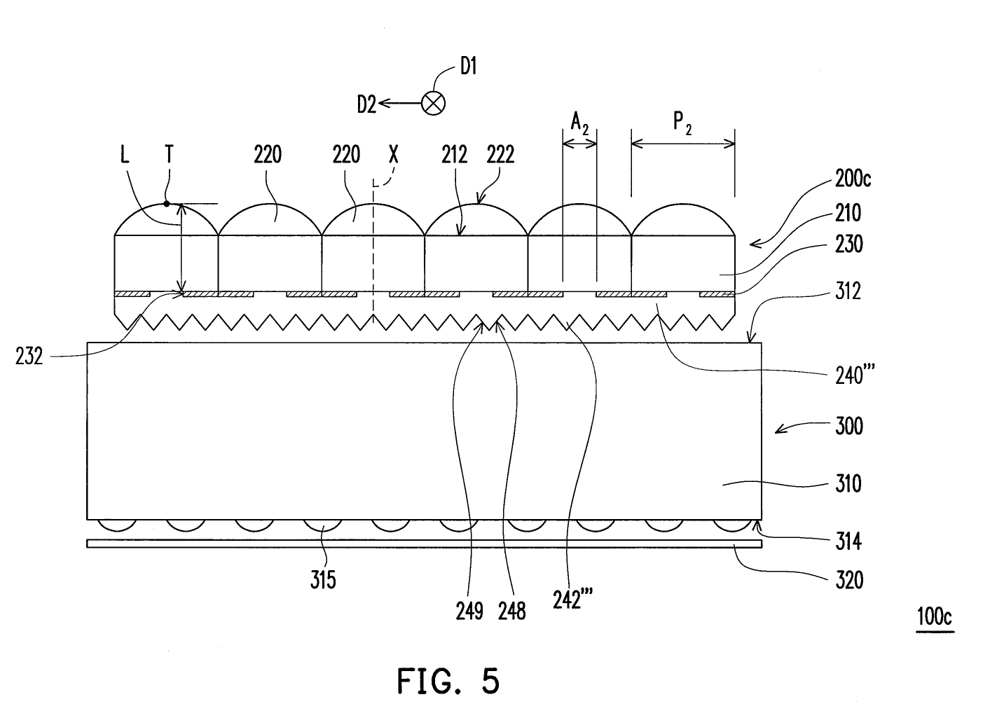

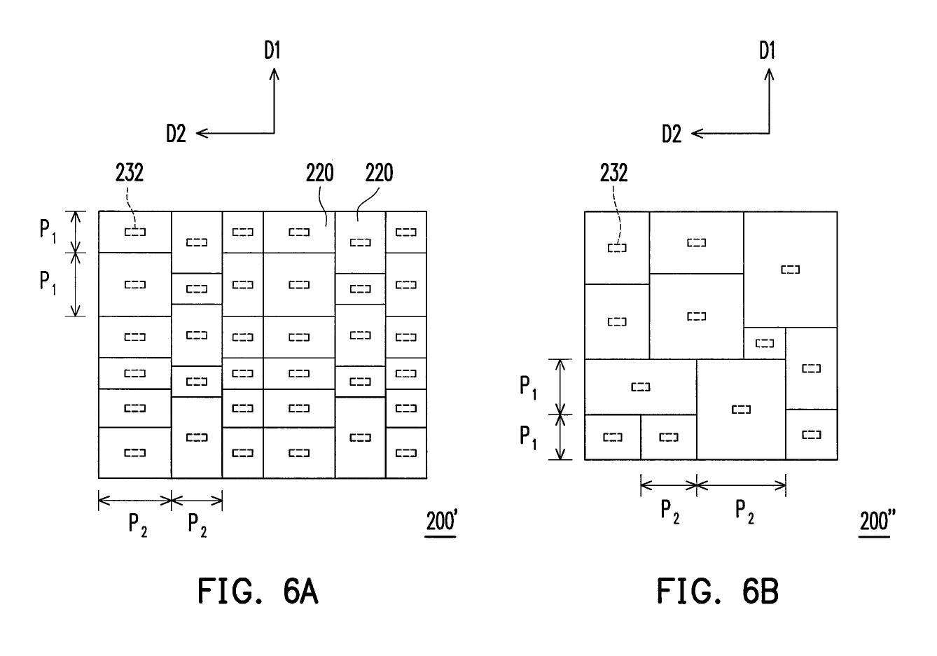

Referring to FIG. 6A, the BEF 200′ in the embodiment is similar to the BEF 200 in FIG. 2B, and the difference between the backlight module 200 and the backlight module 200′ may be described herein. In the BEF 200′ provided by the embodiment, at least parts of the optical structures 220 have different widths P₁ in the first direction D1. The ratio of a maximum value among the widths P₁ of the lenses in the first direction D1 to a minimum value among the widths P₁ of the lenses in the first direction D1 is between 1 and 4. In addition, in the embodiment, at least parts of the optical structures 220 have different widths P₂ in the second direction D2. The ratio of a maximum value among the widths P₂ of the lenses in the second direction D2 to a minimum value among the widths P₂ of the lenses in the second direction D2 is between 1 and 4. Thereby, moiré produced by the BEF 200′ and a LCD panel (not shown) disposed on the BEF 200′ may be reduced through the irregular design of the sizes and positions of the optical structures 220.

Referring to FIG. 6A and FIG. 6B, the difference between the BEF 200″ (as shown in FIG. 6B) and the BEF 200′ (as shown in FIG. 6A) described above may be described herein. In the BEF 200′, the optical structures 220 of a same column in a direction (for example, the first direction D1) have substantially the same width P₂, and at least parts of the optical structures 220 of a same column in another direction (for example, the second direction D2) have different widths P₁. However, in the BEF 200″, at least parts of the optical structures 220 of a same column have different widths P₁ or P₂ in both the first direction D1 and the second direction D2. The BEF 200″ has higher irregularity, while the BEF 200′ is easier to design and fabricate.

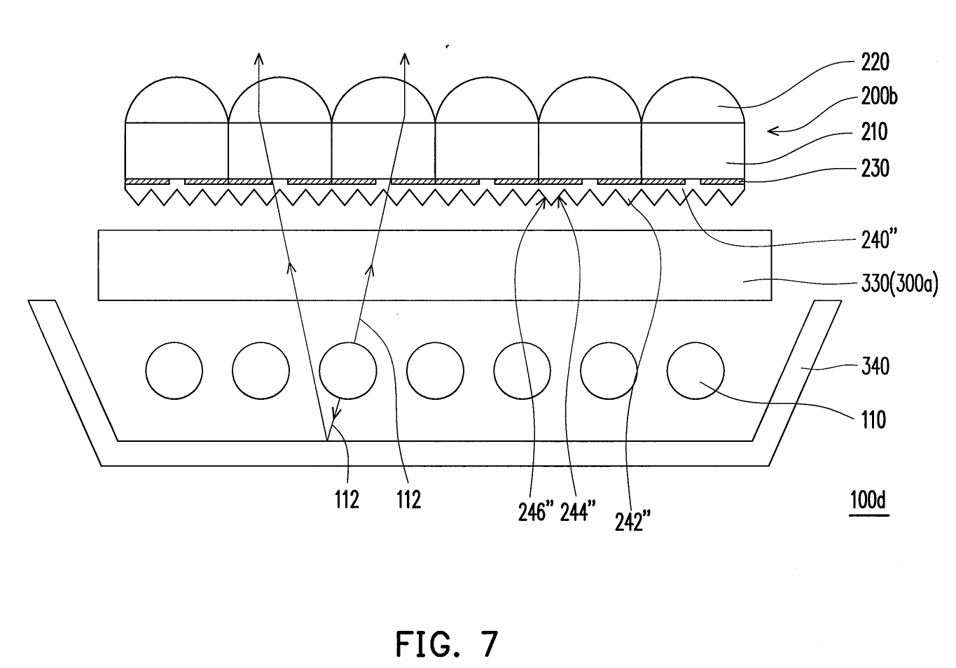

Referring to FIG. 7, the backlight module 100d in the embodiment is partially similar to the backlight module 100 illustrated in FIG. 1A, and the difference between the backlight module 100 and the backlight module 100d may be described herein. The backlight module 100 in FIG. 1A is a side-type backlight module, while the backlight module 100d in the embodiment is a direct-type backlight module. To be specific, the optical unit 300a includes a diffusion plate 330 disposed between the BEF 200b and a plurality of light emitting devices 110, and this is an characteristic of direct-type backlight modules. The light beams 112 emitted by the light emitting devices 110 pass through the diffusion plate 330 to reach the BEF 200 and are diffused by the diffusion plate 330. In the embodiment, the backlight module 100d further includes a light box 340, and the light emitting devices 110 are disposed in the light box 340. The internal wall of the light box 340 has reflection function and may reflect the light beams 112 emitted by the light emitting devices 110 to the diffusion plate 330.

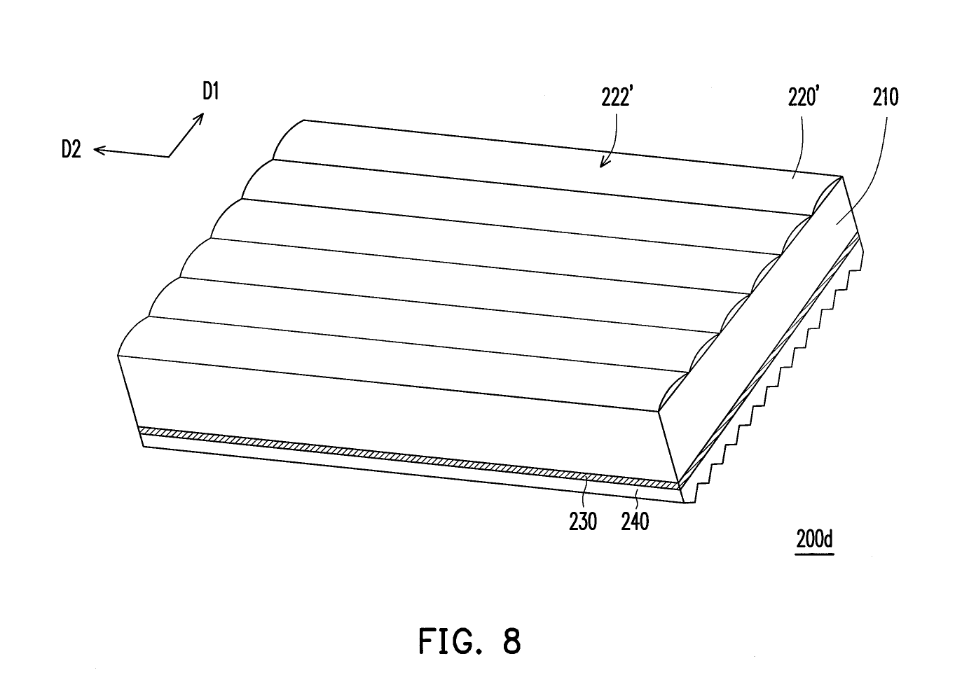

Referring to FIG. 8, the BEF 200d in the embodiment is similar to the BEF 200 illustrated in FIG. 2A, and the main difference between the backlight module 200 and the backlight module 200d is that the optical structures 220′ in the embodiment are lenticulars with rod-shaped convex surfaces 222′.

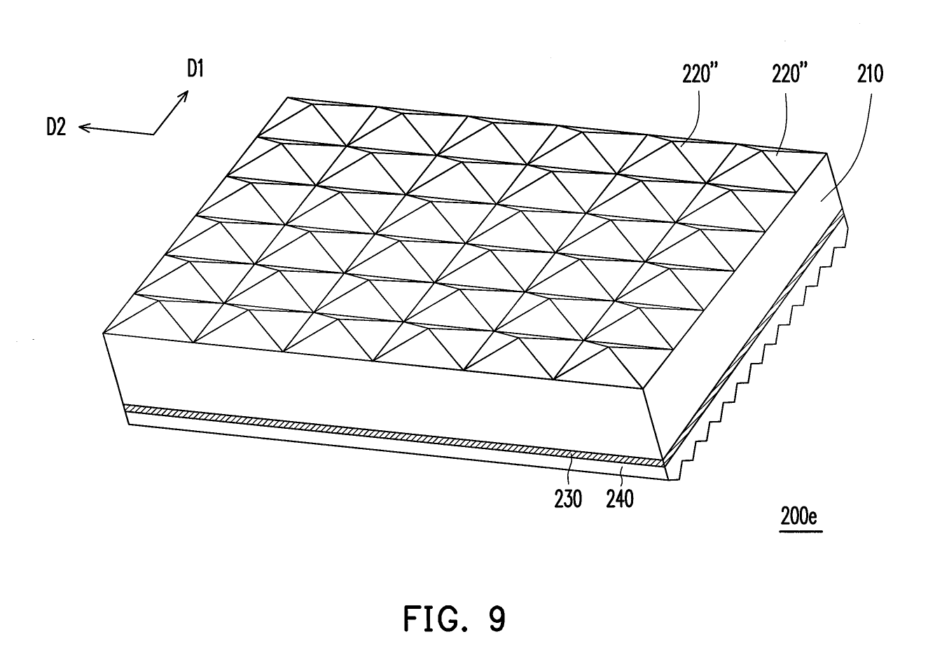

Referring to FIG. 9, the BEF 200e in the embodiment is similar to the BEF 200 illustrated in FIG. 2A, and the main difference between the backlight module 200 and the backlight module 200e is that the optical structures 220″ in the embodiment are polygonal-pyramid-shaped prisms, such as tetragonal pyramid prisms.

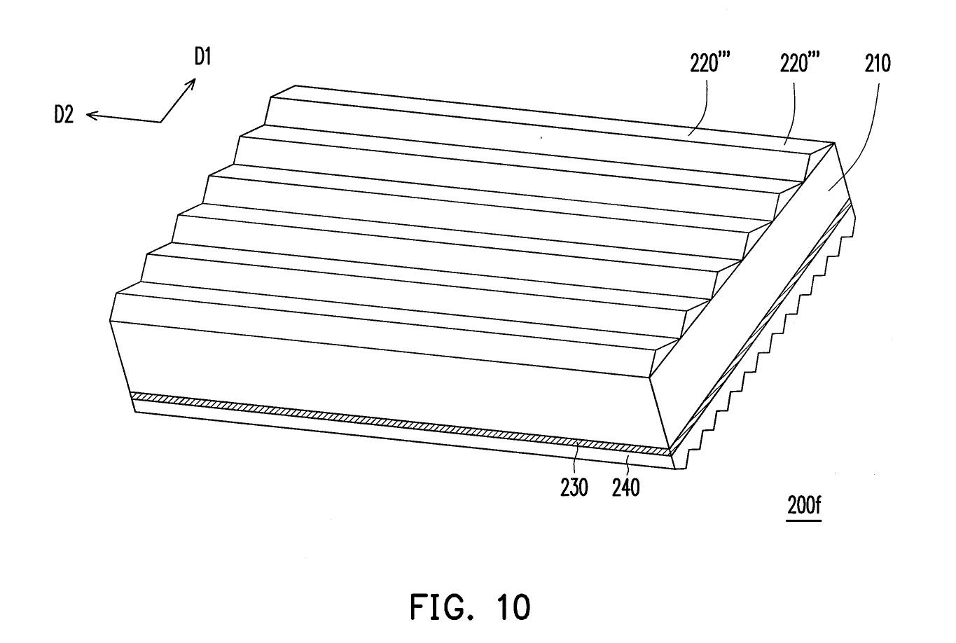

Referring to FIG. 10, the BEF 200f in the embodiment is similar to the BEF 200 illustrated in FIG. 2A, and the main difference between the backlight module 200 and the backlight module 200f is that the optical structures 220′″ in the embodiment are rod-shaped prisms, such as triangular rod prisms.

The type of the optical structures in the BEF is not limited in the invention, and in other embodiments, the optical structures may be any combination of lenses, lenticulars, polygonal-pyramid-shaped prisms, rod-shaped prisms, and other types of optical structures.

As described above, the embodiment or the embodiments of the invention may have at least one of the following advantages, in the BEF according to the embodiments of the invention, the prism structures of a prism layer may refract incident light and allow the incident light to be transmitted in a direction close to the normal direction of a first surface after the incident light passes through the prism structures, and when the incident light is reflected by a reflective layer and accordingly leaves the prism structures, the incident light is refracted by the surface of the prism structures again so that the incident light is transmitted in a direction closer to the normal direction of the first surface. Thereby, the forward luminance of the light emitted by the optical structures, and accordingly the brightness of the surface light source provided by the backlight module in the invention is increased.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A brightness enhancement film, comprising:
a light transmissive substrate, having a first surface and a second surface opposite to the first surface;
a plurality of optical structures, disposed on the first surface;
a reflective layer, disposed on the second surface and having a plurality of light transmissive openings; and
a prism layer, covering the reflective layer and the second surface, and comprising a plurality of prism structures protruded away from the second surface.

2. The brightness enhancement film according to claim 1, wherein each of the prism structures comprises a prism rod, the prism rods are arranged along a first direction, and each of the prism rods is extended along a second direction, wherein the first direction is substantially perpendicular to the second direction.

3. The brightness enhancement film according to claim 2, wherein each of the prism rods is non-mirror-symmetrical in the first direction.

4. The brightness enhancement film according to claim 1, wherein each of the prism structures comprises a polygonal pyramid.

5. The brightness enhancement film according to claim 1, wherein at least a part of the prism structures has different widths in a direction parallel to the second surface, and at least a part of the prism structures has different heights in a direction perpendicular to the second surface.

6. The brightness enhancement film according to claim 1, wherein each of the optical structures comprises a lens, and the light transmissive openings are respectively located on optical axes of the lenses.

7. The brightness enhancement film according to claim 6, wherein each of the lenses has a convex surface facing away from the light transmissive substrate, a curvature radius of the convex surface in a first direction parallel to the first surface is R₁, and a curvature radius of the convex surface in a second direction parallel to the first surface is R₂, the first direction is substantially perpendicular to the second direction, and R₁≠R₂, a distance between a vertex of the convex surface of the lens and the corresponding light transmissive opening is L, a refractive index of the lenses is n, and the brightness enhancement film satisfies L<nR₁/(n−1) and L<nR₂/(n−1).

8. The brightness enhancement film according to claim 7, wherein widths of the light transmissive openings in the first direction are different from widths of the light transmissive openings in the second direction.

9. The brightness enhancement film according to claim 7, wherein at least a part of the lenses has different widths in the first direction, and a ratio of a maximum value among the widths of the lenses in the first direction to a minimum value among the widths of the lenses in the first direction is between 1 and 4.

10. The brightness enhancement film according to claim 9, wherein at least a part of the lenses has different widths in the second direction, and a ratio of a maximum value among the widths of the lenses in the second direction to a minimum value among the widths of the lenses in the second direction is between 1 and 4.

11. The brightness enhancement film according to claim 1, wherein each of the optical structures comprises at least one of a lens, a lenticular, a cone-shaped prism, and a rod-shaped prism.

12. A backlight module, comprising:
at least one light emitting device, capable of emitting a light beam;
a brightness enhancement film, disposed in a transmission path of the light beam; and
an optical unit, disposed in the transmission path of the light beam between the light emitting device and the brightness enhancement film, wherein the brightness enhancement film comprises:
a light transmissive substrate, having a first surface and a second surface opposite to the first surface;
a plurality of optical structures, disposed on the first surface;
a reflective layer, disposed on the second surface, and having a plurality of light transmissive openings; and
a prism layer, covering the reflective layer and the second surface, and comprising a plurality of prism structures protruded away from the second surface.

13. The backlight module according to claim 12, wherein each of the prism structures comprises a prism rod, the prism rods are arranged along a first direction, and each of the prism rods is extended along a second direction, wherein the first direction is substantially perpendicular to the second direction.

14. The backlight module according to claim 13, wherein each of the prism rods is non-mirror-symmetrical in the first direction.

15. The backlight module according to claim 12, wherein each of the prism structures comprises a polygonal pyramid.

16. The backlight module according to claim 12, wherein at least a part of the prism structures has different widths in a direction parallel to the second surface, and at least a part of the prism structures has different heights in a direction perpendicular to the second surface.

17. The backlight module according to claim 12, wherein each of the optical structures comprises a lens, and the light transmissive openings are respectively located on optical axes of the lenses.

18. The backlight module according to claim 17, wherein each of the lenses has a convex surface facing away from the light transmissive substrate, a curvature radius of the convex surface in a first direction parallel to the first surface is R₁, a curvature radius of the convex surface in a second direction parallel to the first surface is R₂, the first direction is substantially perpendicular to the second direction, and R₁≠R₂, a distance between a vertex of the convex surface of the lens and the corresponding light transmissive opening is L, a refractive index of the lenses is n, and the brightness enhancement film satisfies L<nR₁/(n−1) and L<nR₂/(n−1).

19. The backlight module according to claim 18, wherein widths of the light transmissive openings in the first direction are different from widths of the light transmissive openings in the second direction.

20. The backlight module according to claim 18, wherein at least a part of the lenses has different widths in the first direction, and a ratio of a maximum value among the widths of the lenses in the first direction to a minimum value among the widths of the lenses in the first direction is between 1 and 4.

21. The backlight module according to claim 20, wherein at least a part of the lenses has different widths in the second direction, and a ratio of a maximum value among the widths of the lenses in the second direction to a minimum value among the widths of the lenses in the second direction is between 1 and 4.

22. The backlight module according to claim 12, wherein the optical unit comprises a light guide plate, the light guide plate has a third surface, a fourth surface opposite to the third surface, and an incident surface connecting the third surface and the fourth surface, the reflective layer is located between the light transmissive substrate and the third surface, and the light emitting device is disposed beside the incident surface.
